(19) United States
(12) Patent Application Publication
(10) Pub. No.: US 2008/0084482 A1
(43) Pub. Date: Apr. 10, 2008

(54) IMAGE-CAPTURING SYSTEM AND METHOD

(75) Inventors: Emil HANSSON, Malmo (SE); Fredrik RAMSTEN, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/558,358

(22) Filed: Nov. 9, 2006

Related U.S. Application Data
(60) Provisional application No. 60/828,091, filed on Oct. 4, 2006.

(51) Int. Cl. H04N 5/225; H04M 1/00

(52) U.S. Cl. 348/218.1; 455/556.1; 348/E05.048

(57) ABSTRACT

An electronic device may include a first camera and a second camera. The method comprises simultaneously, with the first camera, capturing a picture of a first object and processing it into a first frame and with the second camera, capturing a picture of a second object and processed into a second frame, merging the first frame and the second frame into a merged frame, which merged frame comprises both the captured picture of the first object and the captured picture of the second object.

### RELATED APPLICATION

This application claims priority under 35 U.S.C. § 119 based on U.S. Provisional Application Ser. No. 60/828,091, filed Oct. 4, 2006, the disclosure of which is incorporated herein by reference.

### TECHNICAL FIELD

The present invention relates generally to electronic devices and, in particular, multi-camera devices and methods for merging images captured by two or more of the cameras.

### DESCRIPTION OF RELATED ART

Video telephony communication typically involves showing something and receiving an instant feed-back. During a video call, a user of a video communication device can show either himself or the surroundings to another party to the call. This is not limited to the video telephony situation. For instance, it may also relate to other types of camera-related applications, such as video recording and still photography.

Video telephony-capable handsets may have two cameras, one mounted on the front side of the phone, directed toward a user of the phone, and one mounted on the rear side of the phone, directed toward surroundings viewable to the user. In operation, the user must switch between the cameras to show either himself or the surroundings to another party to the call. This is cumbersome and may be disruptive for the sender and/or the receiver of the captured images.

### SUMMARY

The object of the invention is to provide an electronic equipment portable communication device with an enhanced camera function.

According to a first embodiment of the present invention, the object is achieved by a method in an electronic equipment. The electronic equipment comprises a first camera and a second camera. The method comprising the steps of: With the first camera capturing a picture of a first object and processing it into a first frame simultaneously as with the second camera capturing a picture of a second object and processing it into a second frame. Merging the first frame and the second frame into a merged frame. The merged frame comprises both the captured picture of the first object and the captured picture of the second object.

In another aspect, the merge is performed by making one of the first and second frames smaller and the other larger and put the smaller frame on the top of the larger frame, and wherein the smaller frame is obtained by setting the resolution in the associated camera to the small size or resizing the output data from the associated camera when merging the two frames.

In another aspect, the method comprises the further step of: Sending the merged frame to a displaying device, which displaying device simultaneously displays in its displayer the captured picture of the first object and the captured picture of the second object.

In another aspect, the merged frame is sent via a communications network, preferably a radio access network.

In another aspect, the method comprises the further step of, each of the respective first camera and second camera notifying when a frame is ready for merging.

In another aspect, the step of merging is performed after both the first camera has notified that the first frame is ready for merging and second camera has notified that the second frame is ready for merging.

In another aspect, the first camera and second camera are video cameras and wherein simultaneously, with the first camera a sequence of a pictures of the first object are captured and processed into a sequence of first frames and with the second camera a sequence of pictures of the second object are captured and processed it into a second sequence of frames, which sequence of first frames and sequence of second frames are merged into a sequence of merged frames.

In an another aspect, the merged frame or sequence of frames are sent in real time to the displaying device.

In another aspect, the first camera and the second camera operates at different frame rates and the pace of the highest frame is used as the merging rate.

In another aspect, the method is used for video telephony.

In another aspect, the electronic equipment is a mobile radio terminal.

In another aspect, the electronic equipment is a mobile phone.

In yet another aspect, a computer program product in an electronic equipment comprises computer program code for causing a processing means within a computer placed in the electronic equipment to control an execution of the steps of any of the first to twelfth embodiments, when said code is loaded into the electronic equipment.

In a further aspect, an electronic equipment comprises a first camera and a second camera. The first camera is adapted to capture a picture of a first object and processing it into a first frame simultaneously as the second camera captures a picture of a second object and processes it into a second frame. The electronic equipment further comprises a frame merging unit adapted to merge the first frame and the second frame into one merged frame. The merged frame comprises both the captured picture of the first object and the captured picture of the second object.

In another aspect, the electronic equipment further comprises a transmitter adapted to send the merged frame to a displaying device. The displaying device simultaneously displays in its displayer the captured picture of the first object and the captured picture of the second object.

In another aspect, the merged frame is adapted to be sent via a communications network, preferably a radio access network.

In another aspect, the first camera may comprise a first sensor, which first sensor is adapted to notify when the first frame is ready for merging, and the second camera may comprise a second sensor, which second sensor is adapted to notify when the second frame is ready for merging.

In another aspect, the first camera and second camera are video cameras, and wherein the first camera is adapted to capture a sequence of a pictures of the first object and processing it into a sequence of first frames simultaneously as the second camera captures a sequence of pictures of the second object and processes it into a second sequence of frames. The sequence of first frames and sequence of second frames are adapted to be merged into a sequence of merged frames.

In another aspect, the transmitter further is adapted to send the merged frame or sequence of frames in real time to the displaying device.

In another aspect, the first camera and the second camera are adapted to operates at different frame rates and wherein the frame merging unit is adapted to use the pace of the highest frame as the merging rate.

In another aspect, the first camera further comprises or is connected to a first buffer or memory adapted to store the first frames while waiting to be merged and the second camera comprises or is connected to a second buffer or memory adapted to store the second frames while waiting to be merged.

In another aspect, the electronic equipment comprising the first and second cameras is used for video telephony.

In another aspect, the electronic equipment is a mobile radio terminal.

In another aspect, the electronic equipment is a mobile phone.

Since the first and second camera can be used simultaneously and the first frame and the second frame are merged into a merged frame, the pictures captured by both the first camera and the second camera simultaneously can be displayed in the same picture, which implies no switching between the two cameras is required which in turn implies that that the camera function of the electronic equipment is enhanced.

### BRIEF DESCRIPTION OF THE DRAWINGS

The accompanying drawings, which are incorporated in and constitute a part of the specification, illustrate an implementation of the invention and, together with the description, explain the invention. In the drawings,

FIG. 1 is a schematic block diagram of an electronic device in which systems and methods described herein may be implemented;

FIG. 2 is a functional block diagram of the electronic device of FIG. 1; and

FIG. 3 is a flowchart illustrating a method in the electronic equipment.

### DETAILED DESCRIPTION OF THE INVENTION

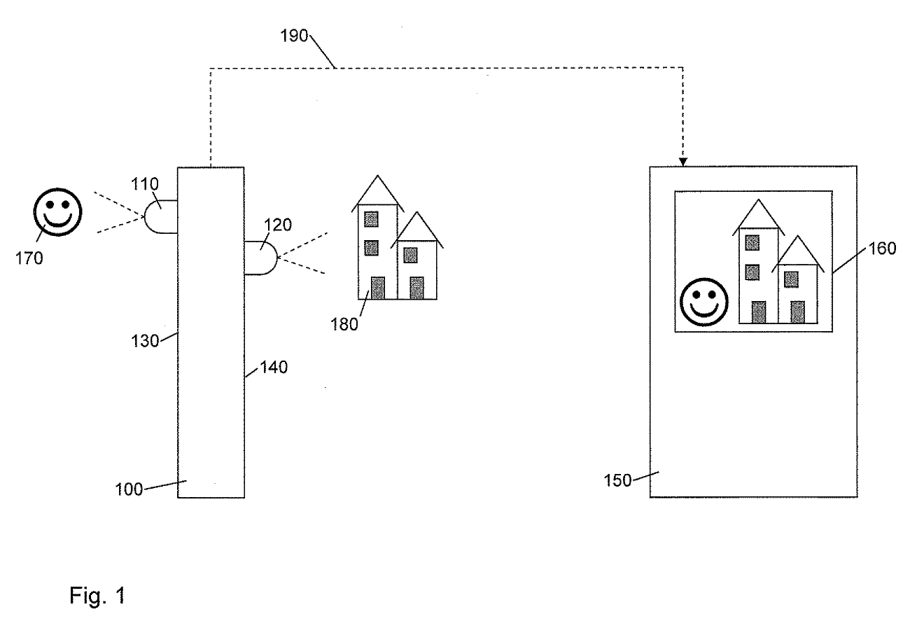

FIG. 1 depicts a profile of an electronic device 100. Electronic device 100 may be configured to connect to a displaying device 150 via a network. Electronic device 100 may include a first camera 110, and a second camera 120. Electronic device 100 may include a portable communication device, a mobile radio terminal, a Personal Digital Assistant (PDA), a mobile phone, or any other electronic device including two or more cameras.

First camera 110 and second camera 120 may be any kind of camera that is capable of capturing images digitally, i.e., converting light into electric charge and process it into electronic signals, so-called picture data. In this document, picture data captured from one picture is defined as one frame, which will be described more in detail further on. Such camera may be a video camera, a camera for still photography or an image sensor, such as Charge Coupled Device (CCD) and Complementary Metal Oxide Semiconductor (CMOS). First and second cameras 110 and 120 may also include a single chip camera, i.e., a camera where all logic is placed in the camera module. A single chip camera only requires power supply, lens and a clock source in order to operate.

Second camera 120 may be the same camera type as first camera 110 or another camera type. As shown in FIG. 1, first camera 110 may be positioned on one side 130 (e.g., front) of electronic device 100, and second camera 120 may be positioned on another side 140 (e.g., rear) of electronic device 100, for example, on substantially opposing sides. Other arrangements are possible. Electronic device 100 may include 3, 4, or more cameras.

Electronic device 100 may be configured to store frames and/or send frames to displaying device 150 via a communication network, such as e.g. a radio access network. The latter is, for example, implementable in video telephony. The frames may or may not be sent in real-time. Displaying device 150 may include any device being capable to display frames, such as a communication device or a mobile phone, including or being configured to be connected to a display 160. Display 160 may be configured to display frames received from electronic device 100.

A user of electronic device 100 may operate first and second cameras 110, 120, substantially simultaneously, to capture images. Captured images may be stored and/or sent, for example, to displaying device 150. Electronic device 100 may be positioned such that first camera 110 points towards a first object 170 while second camera 120 points towards a second object 180.

An exemplary scenario in which implementations of the camera function may be used, include a traveller, Amelie, using a mobile phone including first and second cameras 110, 120 to call a friend, Bert, who may be using a mobile phone. Assume Amelie wishes to show herself to Bert, in front of a building or other landmark, in the display of Bert's mobile phone. In this case, first camera 110 may capture an image that includes object 170, e.g., Amelie, and camera 120 may substantially simultaneously capture an image that includes second object 180, e.g., the building.

In another exemplary scenario, assume a deaf person, Charlotte, wishes to communicate using sign language while using a mobile phone including first and second cameras 110, 120 to call her friend, David, who may be using a mobile phone. Assume Charlotte wishes to show a golf club or other item to David, while discussing the item with David, in the display of David's mobile phone. In this case, first camera 110 may capture images that include Charlotte's hand signing sign language, and second camera 120 may substantially simultaneously capture images that include another object, the golf club, for instance.

A further example is a reporter, Edwin, who may use his mobile phone including first and second cameras 110, 120 to transmit a report to a news channel, Edwin may report a story and the news channel may broadcast the transmitted video call directly, for example, in real time. In this case, first camera 110 may capture images that include Edwin, and second camera 120 may substantially simultaneously capture images that include another object, e.g., the news scene viewable to Edwin, for instance.

A yet further example is researcher, Aase, who may use a mobile phone including first and second cameras 110, 120 to contact a colleague, Guillaume. Aase may wish to discuss research findings with Guillaume, for instance. In this case, first camera 110 may capture images that include Aase, and second camera 120 may substantially simultaneously capture images that include another object, e.g., notes regarding the research findings, lying on a table in front of Aase, for instance.

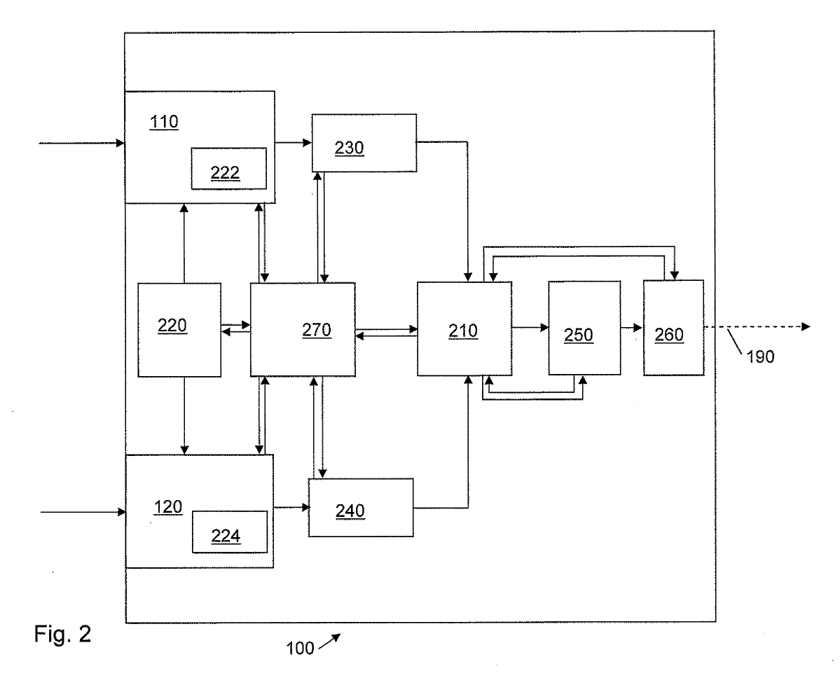

FIG. 2 depicts a functional diagram of various components of electronic device 100. To activate the feature where images from both first camera 110 and second camera 120 may be captured substantially simultaneously, the user may, e.g., select an option from a menu provided to the user. The user may position electronic device 100 such that first camera 110 is directed toward first object 170 (e.g., the user) and, when activated, first camera 110 may capture images that include first object 170. At the same time, second camera 120 may be directed toward second object 180 and, when activated, second camera 120 may capture images that includes second object 180. In one implementation, first camera 110 may capture a first image of first object 170 and process the captured image into a first frame and, simultaneously, second camera 120 may capture a second image that includes second object 180 and process the captured image into a second frame.

Electronic device 100 may include a frame merging unit 210, to which each one of first and second cameras 110, 120 may transmit the respective first and second frames. Frame merging unit 210 may merge the first frame (including first object 170) and the second frame (including second object 180) to form a single merged frame. In one implementation, the merge may be performed by making one of the frames smaller and placing the reduced frame on top of the larger. For example, a display of the merged frame may resemble a picture-in-picture frame. An example of merged images can be seen in display 160 depicted in FIG. 1.

In one implementation, arrangement of the first and second frames to form the merged frame may include placement of the two frames in any configurable arrangement. For example, one frame may be superimposed over another. Another arrangement includes a dual-frame, split-screen display, e.g., side-by-side, top/bottom, etc. Another arrangement includes cropping of one or both of the frames. In one implementation, the user of electronic device 100 may select the arrangement of the frames relative to one another within the merged frame for display. In another implementation, a user of displaying device 150 may select the arrangement of the frames for display. The merged frame arrangement may be altered before, during, or after transmission, for example, during a call. The arrangement of the merged frames may be varied as a function of time.

Video may consist of several individual frames which are displayed to a user substantially in a time-dependent sequence. First camera 110 and second camera 120 may use a same clock 220, and preferably operate at the same frame rate. Clock 220 may be used to synchronize and operate first camera 110 and second camera 120, and clock 220 may be used to instruct when to retrieve a frame. First camera 100 may include a first sensor 222 being configured to generate a notification when the first frame is ready for merging and second camera 120 may include a second sensor 224 being configured to generate a notification when the second frame is ready for merging. The notifying may be performed by, for example, sending a signal to frame merging unit 210. The frame rate is defined herein as the number of frames that are displayed per unit time, e.g. second. For instance, 15 frames per second may be used. Frame merging unit 210 may wait until it has received the frame ready signal from both cameras, before merging the frames including the captured images. First camera 110 may include or be configured to connect to a first buffer 230 or memory and second camera 120 may include or be configured to connect to a second buffer 240, into which the frames may be stored prior to be merged in the merge process. In another implementation, first camera 110 and second camera 120 may operate on frame rates that differ. In which case, the camera having the highest frame rate may set the pace. Then, when a frame is ready from the camera with the highest frame rate, the frame will be merged with the other frame from the camera with lower frame rate.

The image dimensions of the frames to be used in a communication session may determined via a negotiation at the start-up of the communication session between the portable communication device and the receiving communication device, which may be standardized. The merged frame may be of the same resolution as the negotiated one. For standard video telephony, this may be accomplished using, for example, Quarter Common Intermediate Format (QCIF) (176×144 pixels). The smaller frame within the merged frame may have any size up to about QCIF, but preferably the smaller frame would have the size of around a quarter of the frame, for video telephony, for example, that may be about QQCIF (88×72 pixels).

For example, two different approaches of how to obtain the smaller frame may be used. A first technique is to set the resolution of the camera to the small size at the outset. Another technique is to resize the output data from the camera when merging the two frames. For video telephony, which may include real-time communication, it is beneficial to include time delays between the endpoints. Since resizing is time-consuming, setting the resolution of the camera may be the preferable solution. However, the resolution of the camera may be changed if the camera which produces the small frame is to be switched. The communication might, for example, be changed so the frame from first camera 110 becomes more important to the user of the displaying device 150. Then it may be desirable to switch so the frame from first camera 110 will be visible in the large area and frame from second camera 120 in the small area.

Electronic device 100 may further include an encoder 250. Encoder 250 may be used before sending the frames to displaying unit 150. The frames including the merged frames may be sent to encoder 230 for encoding. Encoder 230 may read the merged frames and encode the merged frames according to a suitable standard, such as h.263, MPEG-4 or another type of encoding. Encoder 230 may not detect any difference between a non-merged frame and a merged frame, therefore permitting any encoder to be used.

Electronic device 100 may include a transmitter 260 to be used if the user of electronic device 100 wishes to send the merged frames to displaying device 150. A communication session such as, a video telephony session, may be started between electronic device 100 and displaying device 150.

The merged, and possibly encoded, frames may then be transmitted to displaying device 150, using the set-up communication session between electronic device 100 and displaying device 150, as indicated by a dashed arrow 190 in FIGS. 1 and 2.

Displaying device 150 may receive the merged frames and decode the merged frames, if the merged frames have been encoded. Displaying device 150 may display a merged picture based on the received merged frames comprising first object 170 and second object 180 in display 160. The merged picture may be displayed in accordance with the image size and/or dimensions of the frames negotiated during start-up of the communication session.

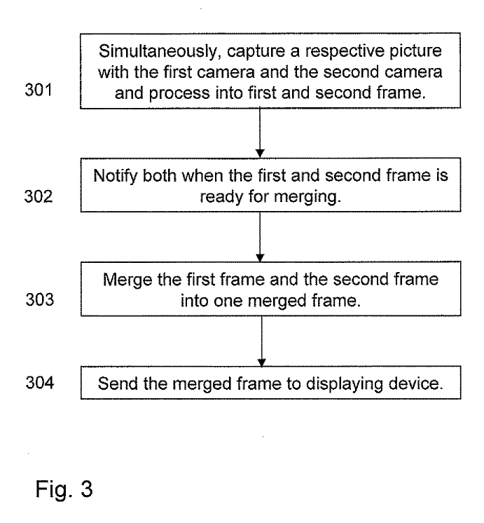

FIG. 3 is a flowchart describing an example of the present method within electronic device 100. The method may include: first camera 110 capturing an image or a sequence of images of first object 170, and processing the captured image(s) into a first frame or a sequence of first frames. Substantially at the same time, second camera 120 may capture an image or a sequence of images of second object 180, and processing the captured image(s) into a second frame or a sequence of second frames (act 301).

Components associated with each of respective first and second cameras 110 may generate a notification when a frame is ready for merging (act 302).

The first frame (or sequence of first frames) and the second frame (or sequence of second frames) may be merged into one merged frame (or sequence of merged frames), which merged frame (or sequence of merged frames) may include both the captured image of first object 170 and the captured image of second object 180 (act 303). The merge process may be achieved by resizing one of the first and second frames smaller and arranging a smaller of the two frames over the larger of the two frames, for example. The smaller frame may be obtained by, e.g., setting the resolution in the associated camera to the small size or resizing the output data from the associated camera when merging the two frames. The merging may be achieved after both first camera 110 has generated a notification that the first frame is ready for merging and second camera 120 has generated a notification that the second frame is ready for merging. First camera 110 and second camera 120 may operate at different frame rates. In which case, the pace of the highest frame may be used as the merging rate.

The merged frame may be sent to a displaying device 150, which may simultaneously display via its displayer 160, the captured image of the first object 170 and the captured image of the second object 180 (act 304). The merged frame may be sent via a communications network, for example, a radio access network. The merged frame or sequence of frames may be sent in real-time to displaying device 150. This may, e.g., be used for video telephony communication with displaying device 150.

The present frame merging mechanism can be implemented through one or more processors, such as a processor 270 in electronic device 100 depicted in FIG. 2, together with computer program code for performing one or more of the various functions of the invention. The program code mentioned above may also be provided as a computer program product, for instance in the form of a data carrier carrying computer program code for performing the present method when being loaded into electronic device 100. One such carrier may be in the form of a CD ROM disc. It is, however, feasible with other data carriers such as a memory stick. The computer program code can furthermore be provided as pure program code on a server and downloaded to electronic device 100 remotely.

It should be emphasized that the term comprises/comprising when used in this specification is taken to specify the presence of stated features, integers, steps or components but does not preclude the presence or addition of one or more other features, integers, steps, components or groups thereof.

The present invention is not limited to the above-describe preferred embodiments. Various alternatives, modifications and equivalents may be used. Therefore, the above embodiments should not be taken as limiting the scope of the invention, which is defined by the appending claims.

1-24. (canceled)

25. In an electronic device including a first camera unit and a second camera unit, a method comprising:
capturing, by the first camera unit, at least one image of a first object;
processing the at least one image into a first frame;
capturing, by the second camera unit, at least one image of a second object;
processing the at least one image into a second frame, wherein the capturing by the first and second camera units occurs substantially simultaneously; and
merging the first frame and the second frame into a merged frame.

26. The method of claim 25, further comprising:
setting a size of one of the first and second frames to be smaller than the other one of the first and second frames and positioning the smaller one of the first and second frames over the other one of the first and second frames, wherein the setting the size includes setting a resolution in the first or second camera units to a reduced size before the corresponding capturing or resizing the first or second frame.

27. The method of claim 25, further comprising:
sending the merged frame to a display; and
displaying the captured at least one image of the first object and the captured at least one image of the second object via the display.

28. The method of claim 27, wherein the merged frame is sent via a communications network.

29. The method of claim 25, further comprising:
generating, by the first camera unit, a notification that the first frame is formed; and
generating, by the second camera unit, a notification that the second frame is formed.

30. The method of claim 29, wherein the merging is performed based on the notifications.

31. The method of claim 25, wherein
the first camera and second camera units are configured to capture video,
the at least one image of the first object includes a set of images of the first object and the first frame includes a sequence of first frames,
the at least one image of the second object includes a set of images of the second object and the second frame includes a sequence of second frames, and
the merged frame includes a series of merged frames.

32. The method of claim 31, further comprising:
sending the series of merged frames in real time to a display of the electronic device.

33. The method of claim 31, wherein the first camera and the second camera units operate at different frame rates using a pace of a frame having a highest frame rate as a merging rate.

34. The method of claim 25, wherein the method is used for video telephony.

35. The method of claim 25, wherein the electronic device comprises a mobile radio terminal.

36. The method of claim 25, wherein the electronic device comprises a mobile phone.

37. A computer program product in an electronic device having a first camera member and a second camera member, including computer program code for causing a processing means within a computer placed in the electronic device to control, when said code is executed by the electronic device, an execution of:
capturing, by the first camera member, at least one image of a first object and processing the at least one image into a first frame;
capturing, by the second camera member, at least one image of a second object and processing the at least one image into a second frame, wherein the capturing by the first and second camera members occurs substantially simultaneously; and
merging the first frame and the second frame into a merged frame.

38. An electronic device comprising:
a first camera component and a second camera component, the first and second camera components having fields of view that differ, the first camera component being configured to capture a first image and process the first image into a first frame, and the second camera component being configured to capture a second image and process the second image into a second frame; and
a merging unit configured to merge the first frame and the second frame into a merged frame.

39. The electronic device of claim 38, further comprising:
a transmitter configured to send the merged frame to a display device, the display device being configured to display the captured first and second images.

40. The electronic device of claim 39, wherein the merged frame is configured to be sent via a communications network.

41. The electronic device of claim 38, wherein the first camera component includes a first sensor, wherein the first sensor is configured to generate a notification when the first frame is ready for merging, and the second camera component including a second sensor, wherein the second sensor is configured to generate a notification when the second frame is ready for merging.

42. The electronic device of claim 38, wherein
the first and second cameras comprise video cameras,
the first camera is configured to capture a sequence of images of a first object and process the image sequence into a sequence of first frames,
the second camera is configured to capture a sequence of images of a second object and process the image sequence into a second sequence of frames, and
the merging unit is configured to merge the first and second sequence of frames into a sequence of merged frames.

43. The electronic device of claim 42, further comprising
a transmitter configured to send the merged sequence of frames in real time to a display of the electronic device.

44. The electronic device of claim 42, wherein the first and seconds camera components are configured to operate at different frame rates and the merging unit is configured to use a pace of a highest frame as a merging rate.

45. The electronic device of claim 38, further comprising:
first memory to store the first frame while waiting to be merged; and
a second memory configured to store the second frame while waiting to be merged.

46. The electronic device of claim 38, wherein the first and second camera components are configured to be used for video telephony.

47. The electronic device of claim 38, wherein the electronic device comprises a mobile radio terminal.

48. The electronic device of claim 38, wherein the electronic device comprises a mobile phone.
